(19) United States
(12) Patent Application Publication
(10) Pub. No.: US 2024/0066725 A1
(43) Pub. Date: Feb. 29, 2024

(54) KNIVES HAVING REPLACEABLE BLADES, CUTTING SYSTEMS, AND METHODS OF USE THEREOF

(71) Applicant: Instant Brands Holdings Inc., Downers Grove, IL (US)

(72) Inventors: Tania Louise Aldous, Niles, IL (US); Randy Soibel, Deerfield, IL (US); Michael Sean Run, Chicago, IL (US)

(21) Appl. No.: 17/899,408

(22) Filed: Aug. 30, 2022

(51) Int. Cl. B26B 5/00; B25G 1/08; B25G 1/10

(52) U.S. Cl. CPC B26B 5/003; B25G 1/08; B25G 1/102; B26B 5/002

(57) ABSTRACT

Knives including utility knives, folding knives, and snap knives are provided. The knives including a blade holder configured to receive a utility blade. The blade holder connected to a handle. The handle having a first grip located on a first side of the handle and a second grip located on a second side of the handle. The first grip having a repeating pattern with a plurality of valleys having a first angular side and a second angular side. The first angular side and the second angular side meet to form a lowermost portion of the valley. The second grip having a surface with a plurality of discrete protrusions thereon along with a ridged surface.

### FIELD

The present application relates to the field of hand tools including knives, such as those with replaceable blades, specifically to utility knives, folding knives, and snap knives with replaceable blades.

### BACKGROUND

Knives, such as utility knives, folding knives, and snap knives, with replaceable blades are widely used due to their typically compact configuration that renders them easy to carry and their reusability light of the blades being replaceable. However, utility knives, folding knives, and snap knives with replaceable blades are not without their disadvantages. One such disadvantage of the utility knives, folding knives, and snap knives available on the market today is that they are generally viewed as being utilitarian in nature so important ergonomic features that would make a user's experience comfortable and more effective are often ignored when designing utility knives, folding knives, and snap knives using replaceable blades.

The ability to cut through a material with a knife that utilizes a replaceable utility razor blade, such as a utility knife, folding knife, or snap knife, depends on a variety of factors, including, e.g., the sharpness of the utility blade and the ability of the user to keep the utility blade at a desired angle (e.g., perpendicular) to the material being cut. Other factors impacting knife performance typically include the ability of the user to apply a downward force towards the material to be cut and the ability of the user to apply a lateral force in a direction away from the material being cut.

Of these factors the only one that is not dependent on the ability of the user to have a secure and stable grip of the knife is the sharpness of the razor blade. Therefore, it would be advantageous to have a knife, such as a utility knife, a folding knife, and a snap knife, that incorporated ergonomic features into the body of the knife to maximize a user's ability to grip the knife, exert downward and lateral force to minimize the time and effort it takes to cut a material using the knives, and to provide a user both stability and control while using the knives.

This application provides such a knife and more specifically it provides such a utility knife, folding knives, and snap knives. These and other advantages, as well as additional features, will be apparent from the description disclosed by the present application.

### BRIEF DESCRIPTION OF THE DRAWINGS

The accompanying drawings incorporated in and forming a part of the specification illustrate several aspects disclosed in the present application and, together with the description, serve to explain the principles disclosed in the present application. In the drawings:

FIG. 1 is a side elevation view of one embodiment of a utility knife according to one aspect of the present application;

FIG. 2 is a side elevation view of the utility knife of FIG. 1 showing the side opposite the side shown in FIG. 1;

FIG. 3 is an exploded perspective side view of the utility knife shown in FIG. 1; and

FIG. 4 is an exploded perspective side view of the utility knife shown in FIG. 1 showing the side opposite the side shown in FIG. 3;

FIG. 5 is a bottom perspective view of the utility knife shown in FIG. 1 showing the storage compartment of the utility knife in an open position;

FIG. 6 is a side elevational view of one embodiment of a folding knife according to one aspect of the present application showing the folding knife in an unfolded position;

FIG. 7 is a side elevational view of the folding knife shown in FIG. 6 showing the side opposite the side shown in FIG. 6 and showing the folding knife in an unfolded position;

FIG. 8 is a side elevational view of the folding knife shown in FIG. 6 showing the folding knife in a folded position;

FIG. 9 is a side elevational view of the folding knife shown in FIG. 6 showing the side opposite the side shown in FIG. 8 and showing the folding knife in a folded position;

FIG. 10 is a side elevational view of the folding knife shown in FIG. 6 showing the folding knife in an unfolded position and further showing the storage compartment in an unfolded position;

FIG. 11 is a bottom perspective view of the folding knife shown in FIG. 6 showing the folding knife in an unfolded position and further showing the storage compartment in an unfolded position;

FIG. 12 is a side elevational view of a second embodiment of a folding knife according to one aspect of the present application showing the folding knife in an unfolded position;

FIG. 13 is a side elevational view of the folding knife shown in FIG. 12 showing the side opposite the side shown in FIG. 12 and showing the folding knife in an unfolded position;

FIG. 14 is an exploded side elevational view of the utility knife shown in FIG. 12;

FIG. 15 is an exploded side elevational view of the utility knife shown in FIG. 12 showing the side opposite the side shown in FIG. 14;

FIG. 16 is a side view of an embodiment of a snap knife according to one aspect of the present application;

FIG. 17 is a perspective side view of the snap knife shown in FIG. 16 showing the side opposite the side shown in FIG. 16;

FIG. 18 is an exploded perspective side view of the snap knife shown in FIG. 16;

FIG. 19 is an exploded perspective side view of the snap knife shown in FIG. 16 showing the side opposite the side shown in FIG. 18;

FIG. 20 is a side elevational view of a second embodiment of a snap knife according to one aspect of the present application;

FIG. 21 is a side elevational view of the snap knife shown in FIG. 20 showing the side opposite the side shown in FIG. 20;

FIG. 22 is an exploded side view of the snap knife shown in FIG. 20;

FIG. 23 is an exploded side view of the snap knife shown in FIG. 20 showing the side opposite the side shown in FIG. 22.

While the present application discloses certain preferred embodiments, there is no intent to limit it to those embodiments. On the contrary, the intent is to cover all alternatives, modifications and equivalents as included within the spirit and scope of the disclosure made in the present application as defined by the appended claims.

### DETAILED DESCRIPTION

Generally speaking, pursuant to these various embodiments, a knife for cutting material includes a handle, a blade holder connected to the handle that configured to receive a knife blade, and one or more handle grips. In some configurations, the handle includes a first grip located on a first side of the handle and a second grip located on a second side of the handle opposite the first side of the handle. By some approaches, the first grip has a repeating pattern with a plurality of indentations or valleys having a first angular side and a second angular side. In such a configuration, the first angular side and the second angular side may meet to form a lowermost portion of the valley. Further, in some embodiments, the second grip includes a surface with a plurality of discrete protrusions thereon, and a ridged surface. By some approaches, the surface between the protrusions is primarily smooth.

The handle grips, such as those illustrated herein, may improve the safety, comfort, and convenience with which such a tool may be wielded. Furthermore, such knives are often used for a prolonged period of time, such as at a job site, and there is an interest in improving the ergonomic features of these tools to make them easier to manipulate for longer periods of time.

In some configurations, the plurality of protrusions on the second grip are disposed on a surface generally perpendicular relative to the ridged surface. Further, in some embodiments, at least some of the individual discrete protrusions are generally triangular in shape. Indeed, in one illustrative approach, each of the plurality of discrete protrusions are generally triangular in shape.

In some embodiments, one or more of the knives disclosed herein may further include a latch or clip. that closes an aperture in the handle when the latch is in a first position and that opens an aperture in the handle when the latch is in a second position. Further, in some aspects, the latch is connected to a spring such that the spring biases against the latch to keep the latch in the first position.

By some approaches, the knives include a storage compartment that is configured to store one or more utility blades and that may take a variety of configurations. In one configuration, the storage compartment includes a door is rotatable about an axis of the handle. Further, in some configurations one or more blades may be secured to the door or a shelf connected thereto, whereas in other configurations, the door provides access to an opening or space where the blades are stored and secured. In one illustrative example, the storage compartment includes a blade clip that biases against the at least one utility blade to keep the utility blade in place when placed in the storage compartment and/or on the storage compartment door or shelf.

For storage purposes a number of the knives described herein have an actuator, button, or lever that moves the blade relative to a sheath, covering, or receiving aperture. By some configurations, such a button or actuator may be pushed to move the blade while applying pressure on the button or actuator to thereby move the knife. In other configurations, a button or actuator may be pushed with one hand while the other finger may be used to pull or move the blade relative to a remainder of the knife. In one illustrative approach, the handle includes a blade lock release button that when actuated causes a blade lock release of the blade holder to release the utility blade. In this manner, movement of the blade is permitted relative to a remainder of the knife such that a user may easily manually grasp a ledge or projection near the blade holder to thereby move the blade.

In some approaches herein, a knife includes a handle with a blade holder that is connected to the handle and configured to receive a utility blade, where the handle has an ergonomic configuration for grasping. To that end, in some configurations, the handle may include a first z-shaped grip portion and a second z-shaped grip portion. By some approaches, the first z-shaped grip portion and the second z-shaped grip portion extend at least partially along a first grip located on the handle.

In some configurations herein, a knife includes a blade housing with a blade mount and a blade movable between at least an extended position where the blade extends partially beyond the blade housing and a retracted position where the blade is primarily disposed within the blade housing via a slide lock, wherein the blade housing has a notch through which the blade is partially exposed when the blade is disposed in the retracted position.

Further, in such a configuration, the handle may have a first grip, a second grip disposed on an opposing side of the handle from the first grip and a latch opening disposed on an end of the handle opposite the blade housing. In some embodiments, the first grip includes a first patterned surface having a series of crosswise channels and the second grip includes a patterned surface with a plurality of discrete protrusions. Further, in some embodiments, the second grip further includes a third patterned surface disposed atop the handle in between portions of the first patterned surface, the third patterned surface includes a series of fins with each of the fins having at least a sloping side and a shelf. In some aspects, the fins further include a flat top surface disposed between the sloping side and the shelf. In addition, in one illustrative approach, the handle further comprises a contoured z-shape configuration disposed adjacent the second patterned grip surface. Further, in some configurations, the crosswise creases have a first and a second surface creating creases with a V-shaped cross section.

In some aspects, a knife includes a blade housing, a blade mount with at least a portion that is rotatably connected to the blade housing such that the blade is rotatably movable between an extended position and a closed position relative to the blade housing, and a handle with one or more grips. In some configuration, the knife includes a first grip, a second grip disposed on an opposing side of the handle from the first grip. In one illustrative configuration, one such first grip includes a first patterned surface having a series of crosswise channels and the second such grip includes a patterned surface with a plurality of discrete protrusions. In some embodiments, the second grip further includes a third patterned surface disposed atop the handle in between portions of the first patterned surface. In such an approach, the third patterned surface may include a series of fins with each of the fins having at least a sloping side and a shelf.

The knife also may include storage for additional blades that may replace the blade secured to the blade mount. In one illustrative example, the knife storage includes a rotatable blade drawer configured to receive at least one additional blade. In some embodiments, such a rotatable blade drawer includes one or more magnetic elements to securely retain the additional blade such as, e.g., during movement of the rotatable blade drawer or use of the knife.

To leverage the use of blade mounted onto the knife, the knife may further include an aperture disposed at an end of the housing opposite the blade, where the aperture is configured to receive a piece of wire and cooperate with the blade to strip an outer sheath of the piece of wire.

In yet other aspects, a knife includes a handle, a blade holder connected to the handle and configured to receive a utility blade, where the handle having a first grip located on a first side of the handle and a second grip located on a second side of the handle opposite the first side of the handle, the first grip having a repeating pattern with a plurality of valleys. the second grip having a smooth surface with a plurality of discrete protrusions thereon, and a ridged surface perpendicular to the plurality of discrete protrusions, and a thumb grip disposed proximate to a terminal end of the handle. In one illustrative example, the thumb grip is located along a top surface of the handle. By some approaches, the thumb grip has a top surface consisting of a repeating pattern of ridges. In some configurations, the knife also includes a lip disposed between the terminal end of the handle and the thumb grip. Further, in some embodiments, the thumb grip is located along a top surface of the blade holder. In addition, in one exemplary configuration, the thumb grip has a top surface consisting of a repeating pattern of ridges.

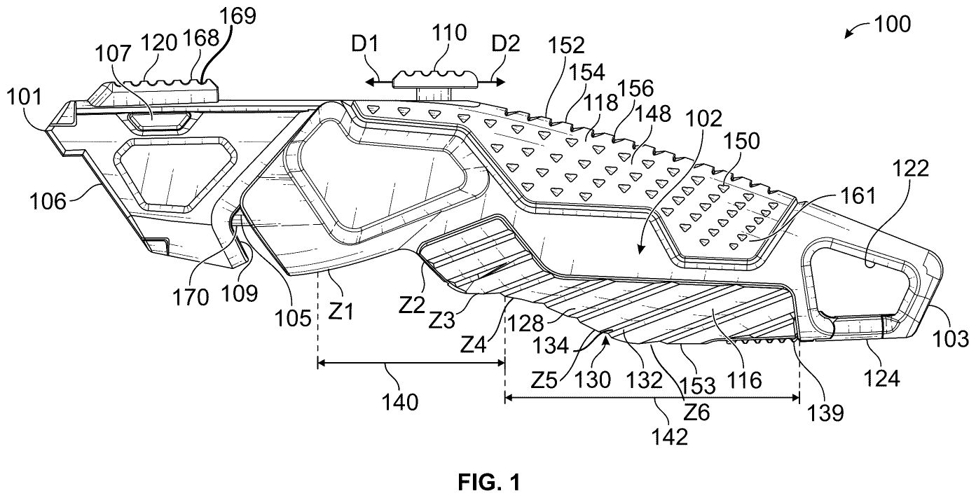

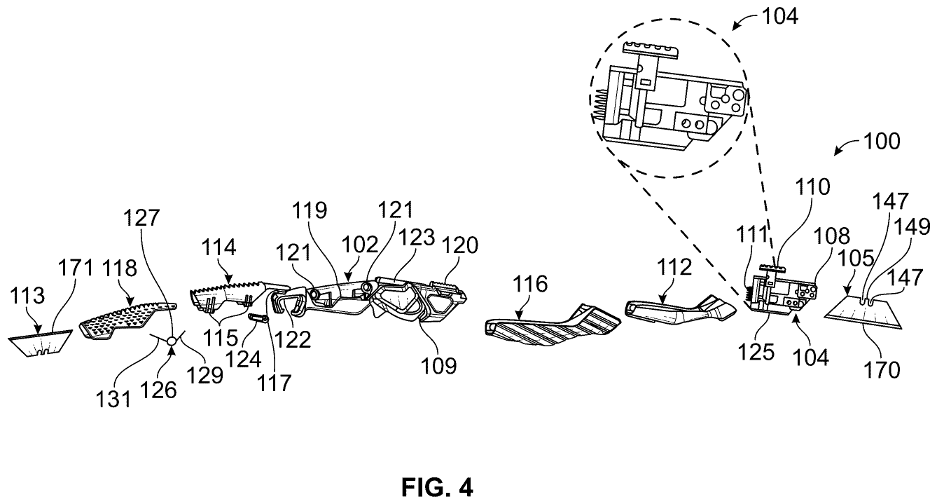

FIGS. 1-5 illustrate one embodiment of a knife, such as a utility knife 100, according to one aspect of the present application. The utility knife 100 has a handle 102 with a generally oblong shape. The handle 102 having a front end 101 and a rear end 103 whereby the front end 101 is located opposite the rear end 103 on the handle 102 and a top side or a top surface 152 and a bottom side or a bottom surface 153 whereby the top surface 152 is located opposite the bottom surface 153 on the handle. The handle 102 further having a first side 161 and a second side 163 whereby the second side 163 is located opposite the first side 161 on the handle 102.

In one illustrative approach, the bottom surface 153 of the handle 102 has ergonomic contouring such as, e.g., having a first z-shaped configuration 140 and a second z-shaped configuration 142. In one example, the first z-shaped configuration 140 includes a first surface Z1, a second surface Z2, and a third surface Z3. In some configurations, the first surface Z1 is disposed between about 60° to 110° relative to the second surface Z2 and the second surface Z2 is disposed between about 60° to 110° relative to the third surface Z3, thereby giving the handle 102 a first generally “Z” shaped configuration along the bottom surface 153 of the handle. In one exemplary approach, the first surface Z1 is generally perpendicular to the second surface Z2 and the second surface Z2 is generally perpendicular to the third surface Z3.

In a similar manner, the second z-shaped configuration 142 also includes a first surface Z4, a second surface Z5, and a third surface Z6. In some configurations, the first surface Z4 is disposed between about 60° to 110° relative to the second surface Z5 and the second surface Z5 is disposed between about 60° to 110° relative to the third surface Z8, thereby giving the handle 102 a second generally “Z” shaped configuration along the bottom surface 153 of the handle. In one illustrative embodiment, the first surface Z4 being generally perpendicular to the second surface Z5 and the second surface Z5 being generally perpendicular to the third surface Z6.

The first z-shaped configuration 140 and the second z-shaped configuration 142 along the bottom surface 153 of handle 102 are designed to optimize a user's grip and control of the handle 102 when using the utility knife 100. For example, when a typical user grips the handle 102 the user's index finger will typically abut against the second surface Z2 of the first z-shaped configuration, the user's middle finger will typically abut against the third surface Z3 of the first-shaped configuration, the user's ring finger will typically abut against the first surface Z4 of the second z-shaped configuration, and the user's little finger will typically abut against second surface Z5 of the second z-shaped configuration 142.

The ability to cut a material with a utility knife 100 depends on a variety of factors, such as, for example, the sharpness of the utility blade 105, the ability of the user to orient the utility blade 105 relative to the material to be cut, the ability of the user to apply a downward force on the material to be cut, and/or the ability of the user to apply a lateral force on the utility knife 100 along the surface of the material to be cut.

Providing the first z-shaped configuration 140 and the second z-shaped configuration 142 along the bottom surface 153 of the handle 102 provides an improved surface for a typical user's fingers to grip the handle 102 of the utility knife 100.

As such, a utility knife 100 by providing a first z-shaped configuration 140 and the second z-shaped configuration 142 along the bottom surface 153 of the handle 102 provides a useful gripping surface for a user, which in turns provides improved control over the utility knife 100 while at the same time maximizing the amount of downward and lateral force a user can apply on the utility knife 100 when cutting a material.

The handle 102 can be formed from any material generally known in the art that is strong and durable such as, but not limited to a metal or plastic material. According to one aspect of the present application the plastic material of the handle 102 may be, but is not limited to being, an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), and combinations thereof, among others.

The front end 101 of the handle 102 typically includes an opening 106 configured to receive a utility blade 105. In some configurations, the utility knife 100 further includes a blade holder 104 located within the handle 102 of the utility knife 100 and configured to receive and secure a utility blade 105 when the utility blade 105 is inserted into the opening 106 located at the front end 101 of the handle 102.

By some approaches, the blade holder 104 includes a slide button 110 extending from the top surface 152 of the handle 102. In some configurations, the blade holder 104 or portions thereof are configured to move within the handle 102 in a first direction D1 and a second direction D2 that is opposite the first direction D1 when the user applies a lateral force on the slide button 110 in the first direction D1 or the second direction D2 respectively.

In one illustrative configuration, the handle 102 further includes a blade lock release button 107, which may be located proximate to the front end 101 of the handle 102. In use, the blade release lock button 107 is configured to engage with a blade lock mechanism 108 located on the blade holder 104 such that when a user positions the blade holder 104 to align with the blade lock mechanism 108 and actuates the blade lock release button 107 it causes the blade lock mechanism 108 to disengage with and allow the removal of the utility blade 105 that was being secured by the blade holder 104.

To replace the utility blade 105 in the knife 100, a user typically positions the blade holder 104 toward the front end 101 of the handle 102 by actuating the slide lock 110 in direction D1 and then inserting the new utility blade 105 into the opening 106 located at the front end 101 of the handle 102 while engaging the blade lock release button 107. Once the new utility blade 105 has been fully received by the blade lock 108 the user may then disengage the blade lock release button 107 which will cause the blade lock 108 to engage with and secure the new utility blade 105 to the blade lock 104. The user then may actuate the slide lock 110 in direction D2 which will cause the blade holder 104 and the new utility blade 105 that is now coupled to the blade holder 104 to move in direction D2 and into the interior of the handle 102 where the utility blade 105 can be stored in the retracted position until the next time that it is needed.

In use, once the utility blade 105 has been secured to the blade holder 104 the user may apply force in direction D2 on the slide button 110 located on the top surface 152 of the handle 102 which will cause the blade holder 104 to move in direction D2 into the interior of the handle 102. As the utility blade 105 is now coupled with the blade holder 104, the movement of the blade holder 104 in direction D2 will cause the utility blade 105 to also move in direction D2 through the opening 106 located at the front end 101 of the handle 102 and into the interior of the handle 102 thereby causing the utility blade 105 to move from an extended position where the utility blade 105 is at least partially extending from the opening 106 located at the front end 101 of the handle 102 to a retracted position where the utility blade 105 is no longer extending from the opening 106 located at the front end 101 of the handle 102.

Likewise, if a user would like to utilize the utility knife 100 to apply force in direction D1, they may apply the force to the slide button 110 which will cause the blade holder 104 and the utility blade 105 coupled with the blade holder 104 to move in direction D1. If sufficient force is applied by the user on the slide button 110 in direction D1 the utility blade 105 will eventually enter the extended position where the utility blade 105 is at least partially extending out of opening 106 located at the front end 101 of the handle.

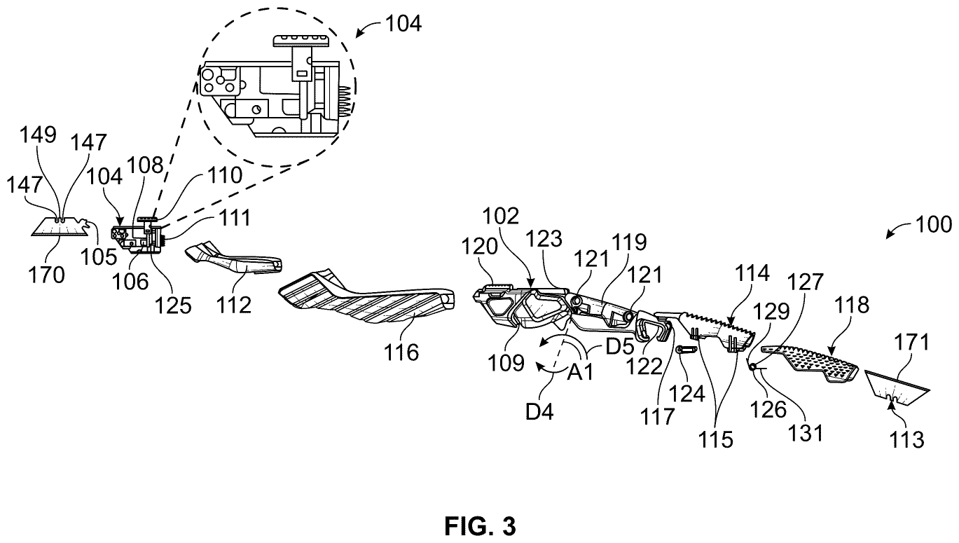

In some configurations, the utility knife 100 also includes one or more grips. As shown in FIG. 3, the utility knife 100 includes a first grip 116 and a second grip 118. The first grip 116 and the second grip 118 may be made from any material that is generally known in the field of art. In one approach, the first grip 116 and the second grip 118 are made from a material that is easy and/or comfortable for a user to grasp with their hands, such as, but not limited to a polymer material, such as, e.g., a natural or synthetic rubber material. Examples of such rubber materials include, but are not limited to, Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), and/or a Hydrogenated Nitrile (HNBR). In another approach, the first grip 116 and the second grip 118 may be made from a plastic material such, as but not limited to a, Thermoplastic Elastomer (TPE) or a Thermoplastic Rubber (TPR).

As illustrated, the first grip 116 extends at least partially along the first side 161 of the handle 102, at least partially along the bottom side 153 of the handle 102, and at least partially along the second side 163 of the handle 102 while the second grip 118 extends at least partially along the first side 161 of the handle, at least partially along the top side 152 of the handle 102, and at least partially along the second side of the handle 102. In other configurations, the first grip 116 and/or second grip 118 may extend over more or less of the handle.

In some configurations, the first grip 116 includes a textured surface or pattern to facilitate increased friction between the handle and the hand in a comfortable manner. In one illustrative approach, the first grip 116 has a repeating pattern with a surface 128 having a plurality of valleys 130. By one approach, the repeating pattern includes a surface 128 with valleys 130 that extend in a crosswise manner from the first side 161 of the handle 102, along the bottom side 153 of the handle, and to the second side. In some configurations, the valleys or repeating surface may extend upward onto the first side 161 and/or up the second side 163 of the handle 102. The valleys 130 generally have a first angular side 132 and a second angular side 134 that meet to form a lowermost portion 133 in each of the valleys 130. In some of the configurations, the lowermost portion 133 is a linear depression that extends lengthwise across the grip. In use, the valleys 130 extending in a crosswise manner across the first grip 116 provide a means of traction to prevent a user's hand from slipping while using the utility knife 100.

Similarly, the second grip 118 also may include a textured surface or patter facilitating an increase of friction between the handle and the user's hand. In one approach, the second grip 118 has a surface 148, which may be generally smooth, that has a plurality of discrete protrusions 150 disposed thereon. In some embodiments, the discrete protrusions 150 are disposed along the first side 161 and/or the second side 163 of the handle 102. The plurality of discrete protrusions 150 may be, but are not required to be, uniformly spaced out along the surface 148 of the second grip 118. The plurality of discrete protrusions may be any shape generally known in the art, such as, but not limited to being triangular in shape. The second grip 118 also may include a plurality of ridges or a plurality of fins 154 interspersed between a plurality of notches, depressions, or gullies 156 that are at least partially extending along the top side 152 of the handle 102. The plurality of discrete protrusions 150 provided on the second grip 118 provide an additional means of traction to prevent a user's hand from slipping while using the utility knife 100.

As discussed above, when a typical user grips the handle 102 of the utility knife 100 they will typically place their index finger and middle finger on the first z-shaped configuration 140 and their index finger and little finger on the second z-shaped configuration 142. As will further be understood by those of ordinary skill in the art, when a typical right handed user grips the handle 102 at least a portion of their palm will come into contact with at least a portion of the second grip 118 that extends along the second side of the handle 163 and at least a portion of their palm will come into contact with a portion of the second grip 118 that extends along the top side 152 of the handle 102. On the other hand, when a typical left-handed user grips the handle 102 at least a portion of their palm will come into contact with at least a portion of the second grip 118 that extends along the first side of the handle 161 and at least a portion of their palm will come into contact with a portion of the second grip 118 that extends along the top side 152 of the handle 102.

Thus, in some configurations, a utility knife 100 having a first grip 116 that extends at least partially along the first side 161 of the handle 102, the bottom surface 153 of the handle 102, and at least partially along the second side 163 of the handle 102 and a second grip 118 that extends at least partially along the first side 161 of the handle 102, the top surface 152 of the handle 102, and the second side 163 of the handle 102 helps maximizes the amount of gripping surface a user's hand will come into contact with when gripping the handle 102 of the utility knife 100 disclosed herein.

In one illustrative approach, the utility knife 100 also includes a thumb grip 120 that is located along the top surface 152 of the handle 102 and is positioned proximate to the front end 101 of the handle 102. As illustrated, the thumb grip 120 has a patterned surface made from a repeating pattern of ridges 168 and valleys 169.

Providing a thumb grip 120 along the top surface 152 of the handle 102 proximate to the front end 101 of the handle 102 provides a pressure point for a user to place their thumb on and apply a downward force on the utility knife 100, which maximizes the amount of downward force a user can apply of the utility knife 100 when cutting through stronger materials.

As will also be appreciated by those of ordinary skill in the art, the patterned surface made from repeating ridges 168 and valleys 169 provided on the thumb grip 120 provides a surface useful to create increased traction between the user's thumb and thumb grip 120 thereby preventing a user's thumb from slipping of the thumb grip 120 when applying downward force on the handle 102 of the utility knife when cutting through a material.

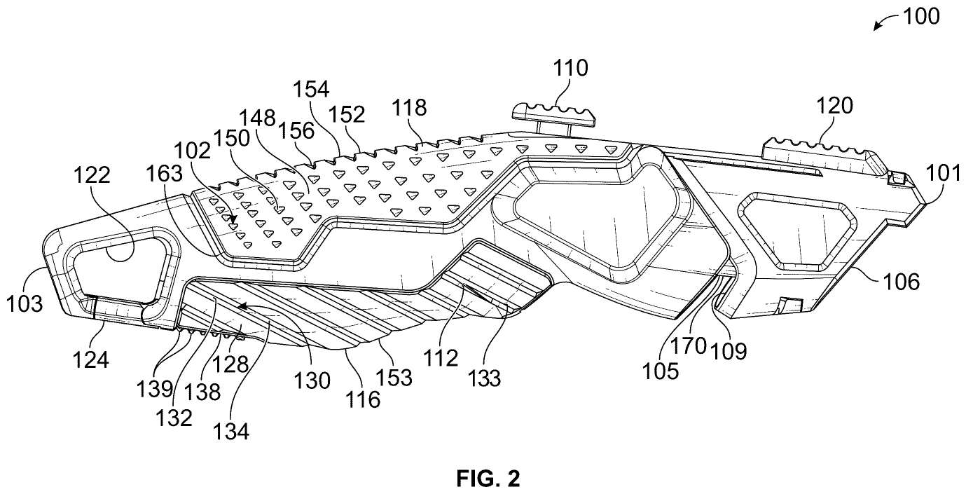

In some embodiments, the utility knife 100 is also provided with a notch 109. As illustrated, the notch 109 in the handle 102 may extend from the bottom side 153 of the handle and at least partially along both the first side 161 and the second side 163 of the handle 102. As best illustrated in FIGS. 1 and 2, the notch 109, in one configuration, extends at least partially into the interior of the handle 102 such that when the utility blade 105 is in the retracted position at least a portion of the edge 170 of the utility blade 105 is exposed proximate to a terminal end of the notch 109.

In some aspects, providing the notch 109 in the handle 102, such that at least a portion of the edge 170 of the utility blade 105 is exposed when the utility blade 105 is in a retracted position, allows a user to cut material, such as but not limited to, a piece of wire, a piece of string, or a piece of rope, that is small enough to be inserted into the notch 109 and come into contact with the portion of the edge 170 of the utility blade 105 that is exposed at the terminal end of the notch 109. According to another aspect, the notch 109 may be used to strip a piece of wire by inserting the piece of wire into the notch 109, such that the piece of wire comes into contact with at least a portion of the edge 170 of the utility blade 105 whereby the edge 105 of the utility blade 105 can be used to strip the insulation off of the piece of wire. According to still yet another aspect, the notch 109 may also be used to trim or snip one or more pieces of thread by inserting the one or more pieces of thread into the notch 109, such that the one or more pieces of thread come into contact with at least a portion of the edge 170 of the utility blade 105 and applying force on the one or more pieces of thread against the edge 170 of the utility blade 105 until the thread is cut by the edge 170 of the utility blade 105. Providing the notch 109 in handle 102 of the utility knife 100 as shown allows users to cut material small enough to fit into the notch 109 without having to expose their hands to the edge 170 of the utility blade 105 as would be required when cutting the material by placing the utility blade 105 in the extended position.

The utility knife 100, in some configurations, also includes an aperture 122 that is generally located proximate to the rear end 103 of the handle 102 and extends from the first side 161 of the handle 102 all the way through the handle 102 to the second side 163 of the handle 102. For example, a clip or latch 124 is provided that makes up a portion of the bottom surface 153 of the handle 102 that is located adjacent to the aperture 122. Accordingly, a spring 126 also may be provided that has a body 127 and a first extension 129 extending from the body 127 in a first direction and a second extension 131 extending from the body 127 in a second direction that is generally perpendicular to the first extension 129. The first extension 129 of the spring 126 is typically coupled to a portion of the handle 102 located adjacent to the aperture 122 and the second extension 131 of the spring 126 is coupled to the latch 124 that forms a portion of the bottom surface 153 adjacent to the aperture 122.

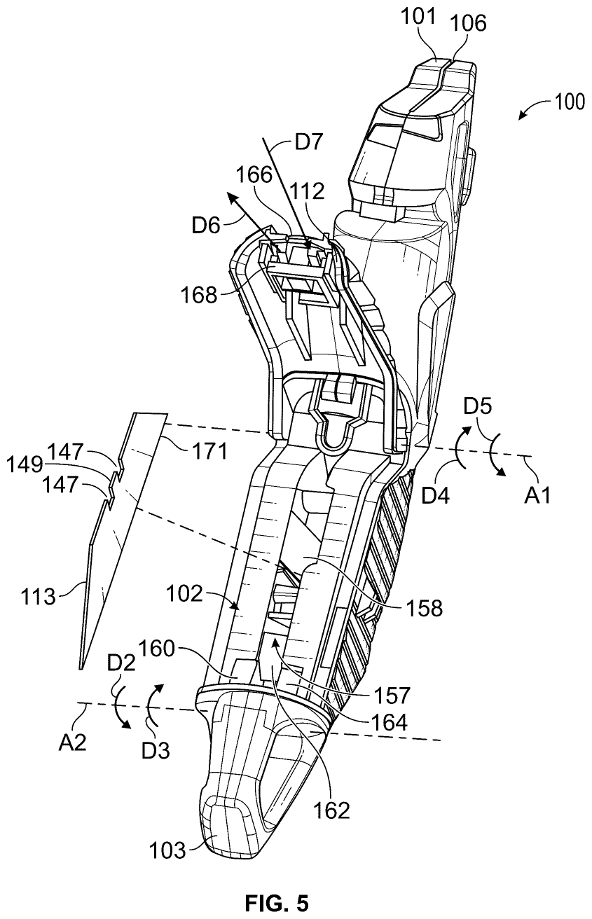

When the first extension 129 of the spring 126 is coupled to the handle 102 and the second extension 131 of the spring 126 is coupled to the latch 124 it causes the spring 126 to provide a biasing force on the latch 124 to keep the latch 124 in a first position where the latch 124 is biased in direction D3 about axis of rotation A2 (see FIG. 5) such that the latch 124 is biased against a portion of the handle 102 that causes the latch 124 to sit flush with and form part of the bottom surface 153 of the handle 102.

By some approaches, the latch 124 can also be rotated about axis A2 to a second position by applying force on the clip in direction A2 in direction D2 that is greater than the force that the spring is biasing the latch 124 against the body in direction D3. Accordingly, when a user applies sufficient force in direction D2 to overcome the biasing force being applied on the latch 124 in direction D3 by the spring 126 it will cause the latch 124 to rotate in direction D2 about axis of rotation A2 to provide an opening in the bottom surface 153 of the handle 102 that leads to aperture 122 that extends through the handle 102.

In use, when the latch 124 is rotated to its second position where an opening is created between the bottom side 153 of the handle 102 and the aperture 122 extending through the handle 102 it creates an opportunity for a user to place an object, such as, but not limited to a belt loop, a loop of a tool bag, or a clip on a tool bag, through the bottom side 153 of the handle 102 and into the aperture 122 extending through the handle 102. The user can then release the latch 124 from which will cause the spring 126 to bias the latch 124 back in direction D2 until the latch 124 returns to the first position where the latch 124 is flush with the bottom side 153 of the handle 102 and the opening into the aperture 122 is closed.

In light of this, the aperture 122 in the handle 102 can therefore be used as an effective means to both hang and secure the utility knife 100 to an object, such as, but not limited to a belt loop, a loop of a tool bag, or a clip on a tool bag, when the object is placed through the aperture 122 provided in handle 102 of the utility knife 100.

In the illustrative example of FIG. 5, the utility knife 100 also includes a storage compartment 157 disposed within the interior of the handle 102. The storage compartment is typically sized and configured to store one or more replacement or additional blades that can be coupled to a blade holder or mount. In some approaches, the utility knife 100 also includes a storage compartment door 112 that is rotationally coupled to the handle 102 such that the storage compartment door 112 can be rotated in direction D4 about axis of rotation A1 to access the storage compartment 157 and then rotated in direction D5 about axis of rotation A1 to close the storage compartment 157.

In such a configuration, the storage compartment door 112 also may include a locking mechanism 166 that is configured to secure the storage compartment door 112 relative to the handle 102 when the utility knife 100. The locking configuration is likely be used when the knife is being stored and when it is in use. In one approach, the locking mechanism 166 includes a slide button 138 (see, e.g., FIGS. 1 and 2) that has ridges 139 along its surface and is located on the exterior surface of the storage compartment door 112 that makes up a portion of the bottom surface 153 of the handle 102. The slide button 138 is mechanically coupled to a locking bolt 168 located along an interior surface of the storage compartment door 112. In one example, the interior surface 166 of the storage compartment 157 also includes a first flange 160 and a second flange 164 that are positioned adjacent to the locking bolt 168 when the storage compartment door 112 is a closed position.

In one illustrative approach, to lock the storage compartment door 112 to the handle 102 a user will rotate the storage compartment door 112 in direction D5 until the storage compartment door 112 is flush with the handle 102. When the storage compartment door 112 is flush with the handle 102 the locking bolt 168 will be aligned with a gap provided between the first flange 160 and handle 102 and the second flange 164 and the handle 102. To lock the storage compartment door 112 to the handle 102 a user will the actuate the slide button 138 in direction D6, which will also cause the locking bolt 168 to move in direction D6 as the locking bolt 168 is mechanically coupled to the slide button 138. The movement of the locking bolt 168 in direction D6 will cause the locking bolt 168 to be received within the gaps located between the first flange 160 and the handle 102 and the second flange 164 and the handle 102. When the locking bolt 168 has been at least partially received within the gaps located between the first flange 160 and the handle 102 and the second flange 164 and the handle 102 the storage compartment door 112 will be unable to be rotated in direction D4 to open the storage compartment door 112 due to the locking bolt 168 contacting the underside of the first flange 160 and the second flange 164 that the locking bolt 168 is positioned underneath.

In some embodiments, to unlock and open the storage compartment door 112 the user will actuate the sliding button 138 in direction D7, which will also cause the locking bolt 168 in direction D7. Once the sliding button 138 has been sufficiently moved in direction D7 that the locking bolt 168 is no longer located in the gap provided between the first flange 160 and the handle 102 and the second flange 164 and the handle 102 then the storage compartment door 112 can then the storage compartment 157 can be accessed by a user by rotating the storage compartment door 112 in direction D4 about axis of rotation A1.

In use, the storage compartment 157 will typically be used to store one or more additional or replacement utility blades 113. The storage compartment 157 also may include a biasing clip 158 that is configured to be biased towards an interior wall 144 of the storage compartment 157. By some approaches, to safely store the replacement utility blades 113 within the storage compartment 157 a user will pull the biasing clip 158 in a direction away from the interior wall 144 that the biasing clip 158 is configured to be biased towards and insert the replacement utility blade 113 between the interior wall 144 and the biasing clip 158 with the edge 171 of the replacement utility blade 113 pointing towards the floor 145 of the storage compartment 157. In such a configuration, then the replacement utility blade 113 has been positioned between the interior wall 144 and the biasing clip 158 the user can then release the biasing clip 158, which will cause the biasing clip 158 to bias towards the interior wall 144 where it will come into contact with and secure the replacement utility blade 113 by biasing the replacement utility blade 113 against the interior wall 144 of the storage compartment 157.

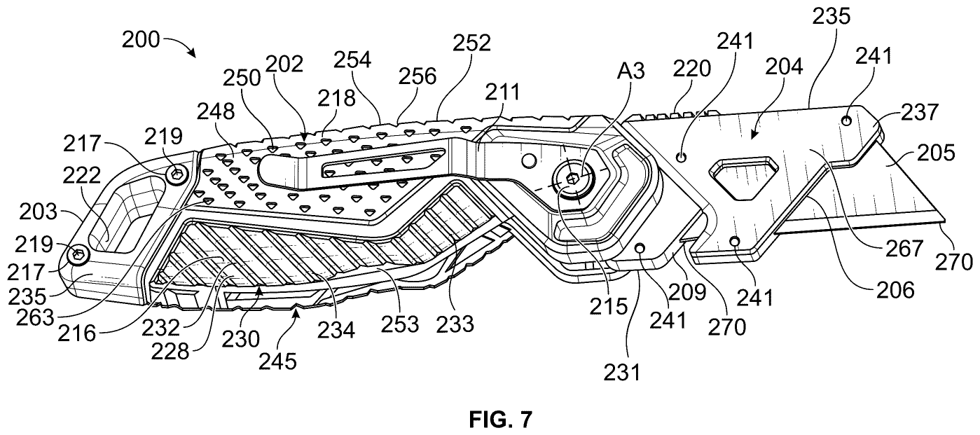

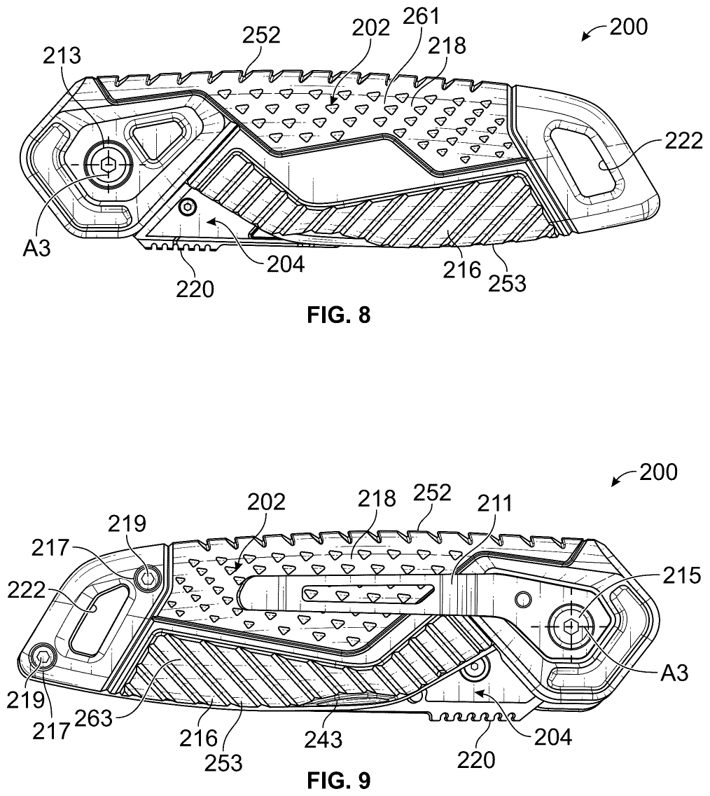

FIGS. 7-11 illustrates another embodiment of a knife, such as a folding knife 200, according to one aspect of the present application. The folding knife 200 has a handle 202 with a generally oblong shape and a blade holder 204 that is rotationally coupled to the handle 202, such that the blade holder 204 can rotate about axis of rotation A3 in both direction D8 and direction D9 that is opposite the direction D8. The blade holder 204 being rotationally secured to the handle 202 via a first fastener 213 and a second fastener 215 located at the axis of rotation A3. The first fastener 213 and the second fastener 215 can be any type of fastener that can provide an axis of rotation between the handle 202 and the blade holder 204.

The handle 202 having a front end 201 and a rear end 203 whereby the front end 201 is located opposite the rear end 203 on the handle 102 and a top surface 252 and a bottom surface 253 whereby the top side or top surface 252 is located opposite the bottom side or the bottom surface 253 on the handle. The handle 202 further having a first side 261 and a second side 263 whereby the second side 263 is located opposite the first side 261 on the handle 202.

In one illustrative approach, the bottom surface 253 of the handle 202 has ergonomic contouring, such as, e.g., having a first z-shaped configuration 240 and a second z-shaped configuration 242. In one example, the first z-shaped configuration 240 includes a first surface Z7, a second surface Z8, and a third surface Z9. In some configurations, the first surface Z7 is disposed between about 60° to 110° relative to the second surface Z8 and the second surface Z8 is disposed between about 60° to 110° relative to the third surface Z9, thereby giving the handle 202 a first generally “Z” shaped configuration along the bottom surface 253 of the handle. In one exemplary approach, the first surface Z7 is generally perpendicular to the second surface Z8 and the second surface Z8 is generally perpendicular to the third surface Z9.

In a similar manner, the second z-shaped configuration 242 includes a first surface Z10, a second surface Z11, and a third surface Z12. In some configurations, the first surface Z10 is disposed between about 60° to 110° relative to the second surface Z11 and the second surface Z11 is disposed between about 60° to 110° relative to the third surface Z12, thereby giving the handle 202 a second generally “Z” shaped configuration along the bottom surface 153 of the handle. In one illustrative embodiment, the first surface Z10 is generally perpendicular to the second surface Z11 and the second surface Z11 is generally perpendicular to the third surface Z12.

The first z-shaped configuration 240 and the second z-shaped configuration 242 along the bottom surface 253 of handle 202 are designed to optimize a user's grip and control of the handle 202 when using the folding knife 200. For example, when a typical user grips the handle 202 the user's index finger will typically abut against the second surface Z8 of the first z-shaped configuration, the user's middle finger will typically abut against the third surface Z9 of the first-shaped configuration, the user's ring finger will typically abut against the first surface Z10 of the second z-shaped configuration, and the user's little finger will typically abut against second surface Z11 of the second z-shaped configuration 242.

The ability to cut a material with a folding knife 200 depends on a variety of factors, such as, for example, the sharpness of the utility blade 205, the ability of the user to keep the utility blade 205 perpendicular to the material to be cut, the ability of the user to apply a downward force on the material to be cut, and/or the ability of the user to apply a lateral force on the utility knife 200 along the surface of the material to be cut.

Providing the first z-shaped configuration 240 and the second z-shaped configuration 242 along the bottom surface 253 of the handle 202 as shown provides a surface useful for a typical user's fingers to grip the handle 202 of the folding knife 200.

As such, a folding knife 200 having a first z-shaped configuration 240 and the second z-shaped configuration 242 along the bottom surface 253 of the handle 202 provides an improved gripping surface for a user, which in turns provides increased control over the folding knife 200 while at the same time maximizing the amount of downward and lateral force a user can apply on the folding knife 200 when cutting a material.

The handle 202 can be formed from any material generally known in the art that is strong and durable such as, but not limited to a metal material. According to one aspect of the present application the metal material of the handle 202 may be, but is not limited to being, a Zinc Alloy, Gray Iron, White Iron, Ductile Iron, Stainless Steel, Carbon Steel, a Copper-Based Alloy, a Nickel-Based Alloy, an Aluminum Alloy, Magnesium, Zinc, Tin and/or Lead.

The handle 202 of the folding knife 200 also includes a first grip 216 and a second grip 218. The first grip 216 and the second grip 218 may be made from any material that is generally known in the field of art. In one embodiment, the first grip 216 and the second grip 218 is made from a material that is easy and/or comfortable for a user to grasp with their hands, such as, but not limited to a polymer material, such as, e.g., a natural or synthetic rubber material. Examples of such rubber materials include, but are not limited to, Natural Rubber (NR), a Styrene-butadiene rubber (SBR), a Butyl (IIR), a Nitrile (NBR), a Neoprene® (CR), a Ethylene Propylene Diene Monomer (EPDM), a Silicone (Q), a Viton® (FKM), a Polyurethane (AU), and/or a Hydrogenated Nitrile (HNBR). In another approach, the first grip 116 and the second grip 118 may be made from a plastic material such, as but not limited to, a Thermoplastic Elastomer (TPE) or a Thermoplastic Rubber (TPR). In yet another aspect, the first grip 216 and the second grip 218 may be formed into the metal material that makes up the handle, 202, such as, but nit limited to being formed into a Zinc Alloy, Gray Iron, White Iron, Ductile Iron, Stainless Steel, Carbon Steel, a Copper-Based Alloy, a Nickel-Based Alloy, an Aluminum Alloy, Magnesium, Zinc, Tin and/or Lead that may be used to form the handle 202.

As illustrated, the first grip 216 extends at least partially along the first side 261 of the handle 202, at least partially along the bottom side 253 of the handle 202, and at least partially along the second side 263 of the handle 202 while the second grip 218 extends at least partially along the first side 261 of the handle, at least partially along the top side 252 of the handle 202, and at least partially along the second side of the handle 202. In other configurations, the first grip 216 and/or the second grip 218 may extend over more or less of the handle.

In some configurations, the first grip 216 includes a textured surface or pattern to facilitate increased friction between the handle and the user's hand in a comfortable manner. In one illustrative approach, the first grip 216 has a repeating pattern with a surface 228 having valleys 230 that extend in a crosswise manner from the first side 261 of the handle 202, along the bottom side 253 of the handle, and to the second side. In some configurations, the valleys or repeating surface may extend upward onto the first side and/or up the second side 263 of the handle 202. The valleys 230 generally have a first angular side 232 and a second angular side 234 that meet to form a depression or lowermost portion 233 in each of the valleys 230. In some of the configurations, the lowermost portion 133 is a linear depression that extends lengthwise across the grip. The valleys 230 extending in a crosswise manner across the first grip 216 provide a means of traction to prevent a user's hand from slipping while using the folding knife 200.

Similarly, the second grip 218 also may include a textured surface or pattern facilitating an increase in the friction between the handle and the user's hand. In one approach, the second grip 218 has a surface 248, which may be generally smooth, that has may a plurality of discrete protrusions 250 disposed thereon. In some embodiments, the discrete protrusions 250 are disposed along the first side 261 and/or the second side 263 of the handle 202. The plurality of discrete protrusions 250 may be, but are not required to be, uniformly spaced out along the surface 248 of the second grip 218. The second grip 218 also may include a plurality of ridges or a plurality of fins 254 interspersed between a plurality of notches, depressions, or gullies 256 that are at least partially extending along the top side 252 of the handle 202. Similar to those discussed above, the plurality of discrete protrusions 250 provided on the second grip 218 provide an additional means of traction to prevent a user's hand from slipping while using the folding knife.

As discussed above, when a typical user grips the handle 202 of the folding knife 200 they will typically place their index finger and middle finger on the first z-shaped configuration 240 and their index finger and little finger on the second z-shaped configuration 242. As will further be understood by those of ordinary skill in the art, when a typical right handed user grips the handle 202 at least a portion of their palm will come into contact with at least a portion of the second grip 218 that extends along the second side of the handle 263 and at least a portion of their palm will come into contact with a portion of the second grip 218 that extends along the top side 252 of the handle 202.

On the other hand, when a typical left-handed user grips the handle 202 at least a portion of their palm will come into contact with at least a portion of the second grip 218 that extends along the first side of the handle 261 and at least a portion of their palm will come into contact with a portion of the second grip 218 that extends along the top side 252 of the handle 202.

Thus, in some configurations, a folding knife 200 having a first grip 216 that extends at least partially along the first side 261 of the handle 202, the bottom surface 253 of the handle 202, and at least partially along the second side 263 of the handle 202 and a second grip 218 that extends at least partially along the first side 261 of the handle 202, the top surface 252 of the handle 202, and the second side 263 of the handle 202 helps maximizes the amount of gripping surface a user's hand will come into contact with when gripping the handle 202 of the folding knife 200 disclosed herein.

In one illustrative approach, the folding knife 200 also includes a thumb grip 220 that is located along the top surface 282 of the blade holder 204 and is positioned proximate to the rear end 283 of the blade holder 204. As illustrated, the thumb grip 220 has a patterned surface made from a repeating pattern of ridges 268 and valleys 269.

The thumb grip 220 along the top surface 282 of blade holder 204 proximate to the rear end 283 of the blade holder 204 provides a pressure point for a user to place their thumb on and apply a downward force on the folding knife 200, which maximizes the amount of downward force a user can apply on the folding knife 200 when cutting through stronger materials. Disposing the thumb grip 220 along the top surface 282 of the blade holder 204 also provides a textured surface that provides traction to the user when the user is using the folding knife 200 to cut a material.

As used herein, the patterned surface made from repeating ridges 268 and valleys 269 provided on the thumb grip 220 provides a surface useful for creating and/or increasing the traction between the user's thumb and thumb grip 220 thereby preventing a user's thumb from slipping off the thumb grip 220 when applying downward force on the folding knife 200 when cutting through a material.

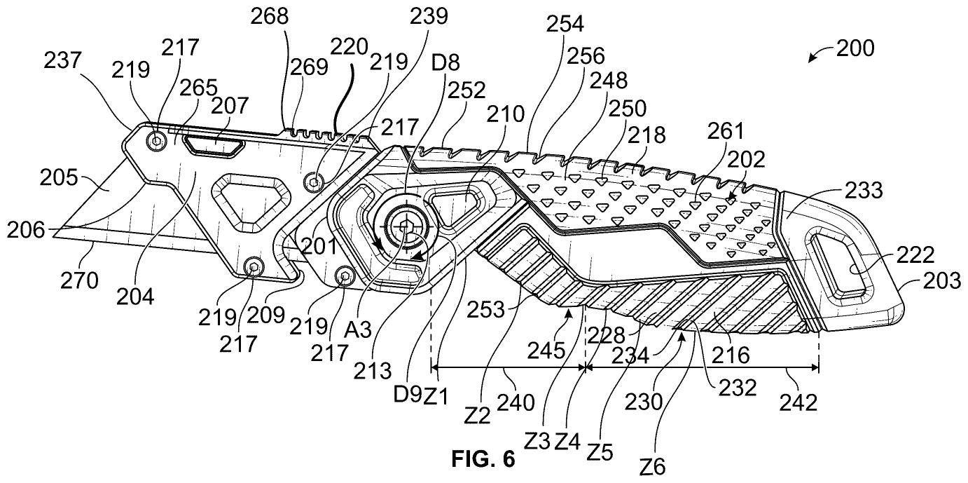

In some embodiments, the folding knife 200 is also provided with a notch 209. As illustrated, the notch 209 in the blade holder 204 may extend from the bottom side 284 of the blade holder 204 and at least partially along both the first side 285 and the second side 287 of the blade holder 204. As best illustrated in FIGS. 6 and 7, in one configuration, the notch 209 extends at least partially into the interior of the blade holder 204 such that when blade holder 204 is in the extended position at least a portion of the edge 270 of the utility blade 205 is exposed proximate to a terminal end of the notch 209.

As used herein, providing the notch 209 in in the blade holder 204, such that at least a portion of the edge 270 of the utility blade 205 is exposed provides an efficient means for cutting materials that are small enough to be inserted into the notch 209 and to come into contact with the edge 270 of the blade holder 204, such as but not limited to, a piece of wire, a piece of string, or a piece of rope.

The folding knife 200, in some configurations, also includes an aperture 222 that is generally located proximate to the rear end 203 of the handle 202 and extends from the first side 261 of the handle 202 all the way through the handle 202 to the second side 263 of the handle 202. In use, the aperture 222 in the handle 202 can be used as a means to hang or secure the folding knife 200 to an object, such as, but not limited to a storage hook or a carabiner, by placing the object through the aperture 222 provided in the handle 202 of the folding knife 200.

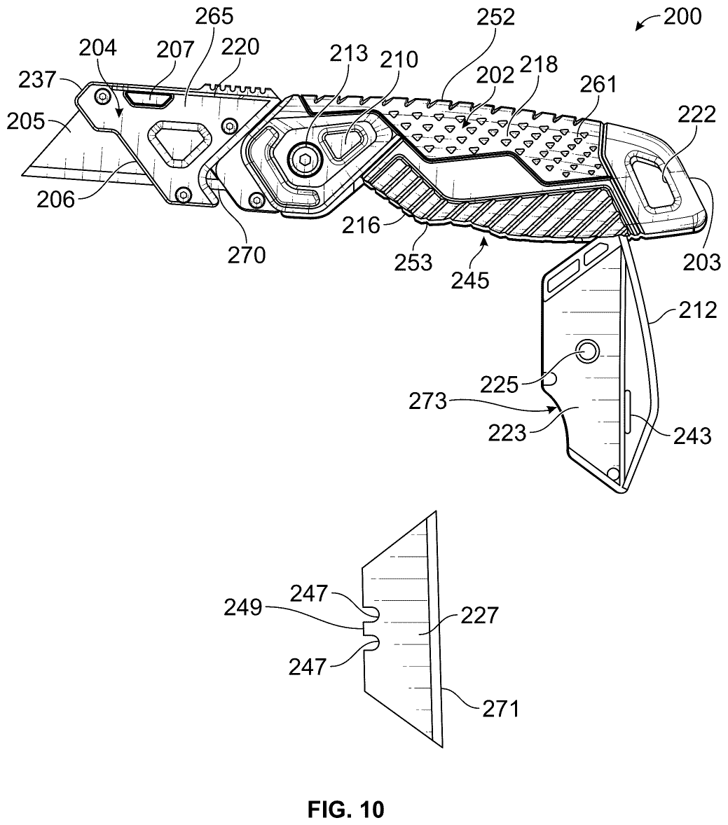

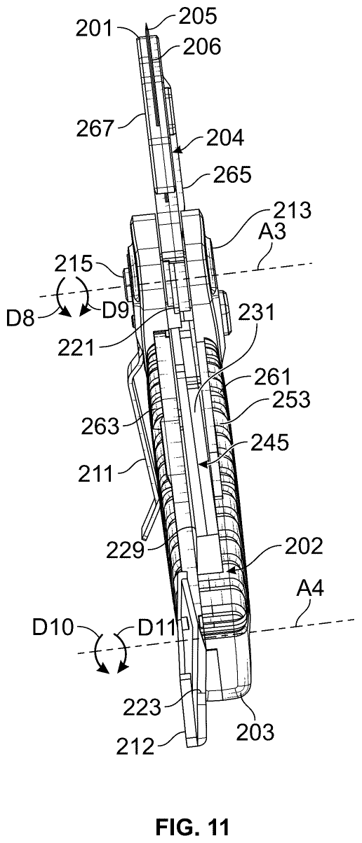

With specific reference to FIGS. 10 and 11, the folding knife 200 also includes a storage compartment. In one configuration, a storage compartment door 212 is rotationally coupled to the handle 202 of the folding knife 200. More specifically, the storage compartment door 212 may be configured to rotate in a first direction D10 and a second direction D11 about axis of rotation A4. The storage compartment door 212 may be configured to hold one or more additional or replacement blades. For example, the storage compartment door 212 may include a shelf or surface 223 that is configured to receive an extra utility blade 227 such that the storage compartment door 212 may rotate back into the handle to store an extra utility blade 227. The shelf or surface 223 of the storage compartment door 212 is configured to receive the extra utility blade 227 such that the edge 271 of the extra utility blade 227 sits flush within the shelf or surface 223 of the storage compartment 212 and the indentations 247 and notch 249 of the extra utility blade 227 are received and secured on the shelf or surface 223 of the storage compartment door 212 by the corresponding geometry of the shelf or surface 223.

In some embodiments, the surface 223 of the storage compartment door 212 includes one or more magnets 225 that are provided as a means to help secure the extra utility blade 227 to the surface 223 of the storage compartment door 212. To remove the extra or replacement utility blade 227 form the shelf or surface 223, a user may manually grasp an edge of the replacement utility blade 227 opposite the edge 271 at the arcuate cutout portion 273 of the storage compartment door 212 and pull upward from the surface 223 to overcome the magnetic force and remove the blade.

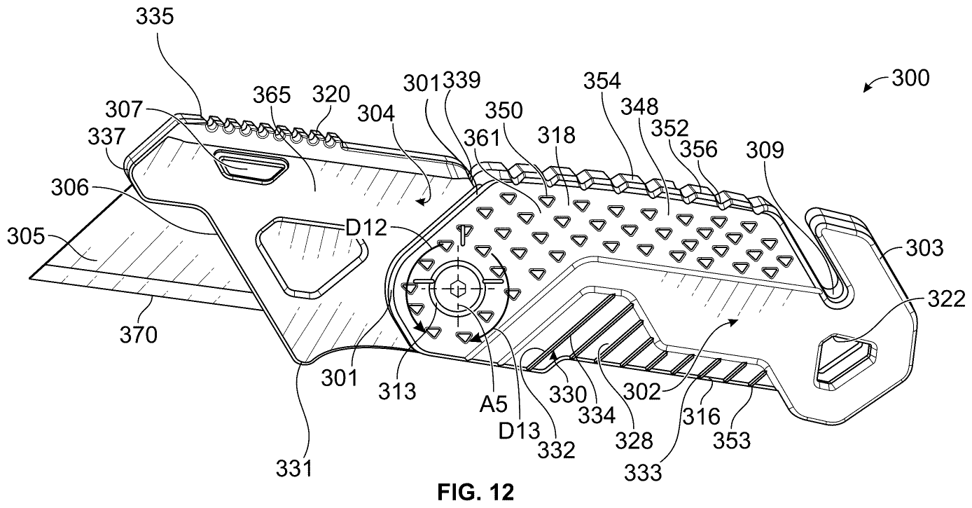

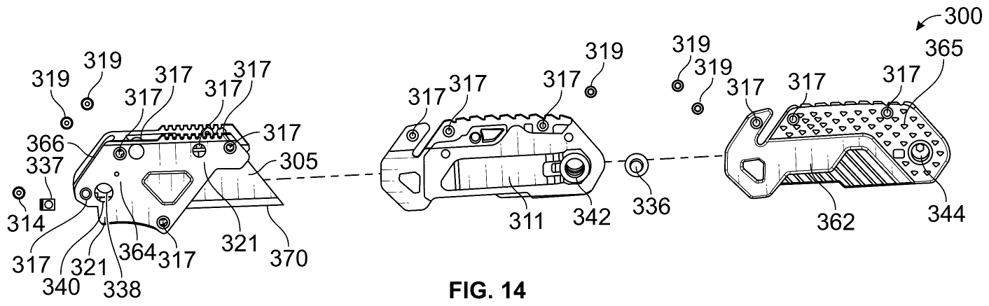

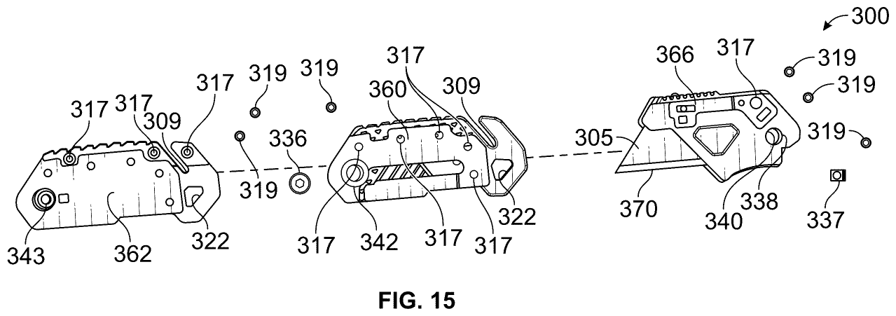

FIGS. 12-15 illustrate another embodiment of a knife, such as a folding knife 300, according to one aspect of the present application. The folding knife 300 has a handle 302 with a generally oblong shape and a blade holder 304 that is rotationally coupled to the handle 302, such that the blade holder 304 can rotate about axis of rotation A5 in direction D12 and direction D13. The blade holder 304 being rotationally secured to the handle 302 via a first fastener 313 and a second fastener 315 located at the axis of rotation A5. The first fastener 313 and the second fastener 315 can be any type of fastener that can provide an axis of rotation between the handle 302 and the blade holder 304.

As shown, the handle 302 has a front end 301 and a rear end 303, a top side or top surface 352 and a bottom side or bottom surface 353, and a first side 361 and a second side 363.

The handle 302 can be formed from any material generally known in the art that is strong and durable such as, but not limited to a metal material. According to one aspect of the present application the metal material of the handle 302 may be, but is not limited to being, a Zinc Alloy, Gray Iron, White Iron, Ductile Iron, Stainless Steel, Carbon Steel, a Copper-Based Alloy, a Nickel-Based Alloy, an Aluminum Alloy, Magnesium, Zinc, Tin and/or Lead.

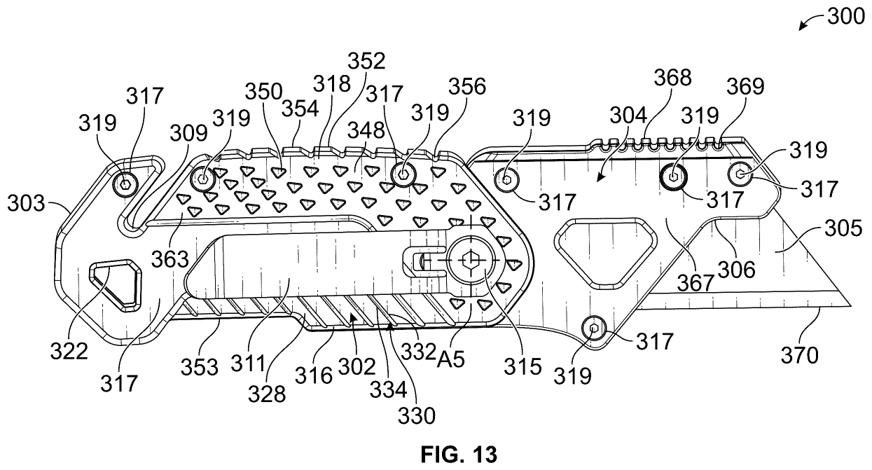

In some configurations, the handle 302 of the folding knife 300 also includes one or more grips. As shown in FIGS. 12 and 13, the handle 302 may include a first grip 316 and a second grip 318. In one approach, the first grip 316 and the second grip 318 will be formed directly into the material that is formed into the handle 102 of the folding knife 300, such as, but not limited to a metal material. According to one aspect of the present application, the first grip 316 and the second grip 318 will be formed into a metallic material, such as, but not limited to, a Zinc Alloy, Gray Iron, White Iron, Ductile Iron, Stainless Steel, Carbon Steel, a Copper-Based Alloy, a Nickel-Based Alloy, an Aluminum Alloy, Magnesium, Zinc, Tin, and/or Lead.

According to another embodiment, the first grip 316 and the second grip may be made from a material that is easy and/or comfortable for a user to grasp with their hands, such as, but not limited to a polymer material such as, e.g., a natural or synthetic rubber material. Examples of such rubber materials include, but are not limited to, Natural Rubber (NR), a Styrene-butadiene rubber (SBR), a Butyl (IIR), a Nitrile (NBR), a Neoprene® (CR), a Ethylene Propylene Diene Monomer (EPDM), a Silicone (Q), a Viton® (FKM), a Polyurethane (AU), and/or a Hydrogenated Nitrile (HNBR). In another approach, the first grip 116 and the second grip 118 may be made from a plastic material such, as but not limited to, a Thermoplastic Elastomer (TPE) or a Thermoplastic Rubber (TPR).

As illustrated, the first grip 316 extends at least partially along the first side 361 of the handle 302, at least partially along the bottom side 353 of the handle 302, and at least partially along the second side 363 of the handle 302 while the second grip 318 extends at least partially along the first side 361 of the handle, at least partially along the top side 352 of the handle 302, and at least partially along the second side of the handle 302. In other configurations, the first grip 316 and/or the second grip 318 may extend over more or less of the handle.

In some configurations, the first grip 316 includes a textured surface or pattern to facilitate increased friction between the handle and the user's hand in a comfortable manner. In one illustrative approach, the first grip 316 has a repeating pattern with a surface 328 having valleys 330 that extend in a crosswise manner from the first side 361 of the handle 302, and to the second side. In some configurations, the valleys 330 have a first angular side 332 and a second angular side 334 that meet to form a lowermost portion 333 in each of the valleys 330. By having the valleys 330 extending in a crosswise manner across the first grip 316, a user is provided a means of traction to prevent a user's hand from slipping while using the folding knife 300.

Similarly, the second grip 318 also may include a textured surface or pattern facilitating an increase in the friction between the handle and the user's hand. in one approach, the second grip 318 has a surface 348, which may be generally smooth, that has a plurality of discrete protrusions 350 disposed thereon. For example, the protrusions 350 may be disposed along the first side 361 and the second side 363 of the handle 302. The plurality of discrete protrusions 350 may be, but are not required to be, uniformly spaced out along the surface 348 of the second grip 318. The second grip 318 also includes a plurality of ridges or plurality of fins 354 interspersed between a plurality of notches, depressions, or gullies 356 that are at least partially extending along the top side 352 of the handle 302. Similar to those discussed above, the plurality of discrete protrusions 350 provided on the second grip 318 provide an additional means of traction to prevent a user's hand from slipping while using the folding knife.

Thus, in some configurations, a folding knife 300 having a first grip 316 that extends at least partially along the first side 361 of the handle 302, the bottom surface 353 of the handle 302, and at least partially along the second side 363 of the handle 302 and a second grip 318 that extends at least partially along the first side 361 of the handle 302, the top surface 352 of the handle 302, and the second side 363 of the handle 302 helps maximizes the amount of gripping surface a user's hand will come into contact with when gripping the handle 302 of the folding knife 300 disclosed herein.

In one illustrative approach, the folding knife also includes a thumb grip 320 that is located along the top surface 382 of the blade holder 304 and is positioned proximate to the rear end 383 of the blade holder 304. As illustrated, the thumb grip 320 has a patterned surface made from a repeating pattern of ridges 368 and valleys 369.

Disposing the thumb grip 320 along the top surface 382 of blade holder 304 proximate to the rear end 383 thereof provides a pressure point for a user to place their thumb on and apply a downward force on the folding knife 300, which maximizes the amount of downward force a user can apply on the folding knife 300 when cutting through stronger materials.

As used herein, the patterned surface made from repeating ridges 368 and valleys 369 provided on the thumb grip 320 provides a surface useful for creating and/or increasing the traction between the user's thumb and thumb grip 320 thereby preventing a user's thumb from slipping off the thumb grip 320 when applying downward force on the folding knife 300 when cutting through a material.

In some embodiments, the folding knife 300 is also provided with a notch 309. As illustrated, the notch 209 in the blade holder 304 may extend from the top side 352 of the blade holder 304 and at least partially along both the first side 361 and the second side 363 of the handle 302. In some embodiments, the notch 309 extends at least partially into the interior of the handle 302 such that when blade holder 304 is rotated into the retracted position at least a portion of the edge 370 of the utility blade 305 is exposed proximate to a terminal end of the notch 309.

As used herein, providing the notch 309 in in the handle 302 that exposes at least a portion of the edge 370 of the utility blade 305 provides an efficient means for cutting materials that are small enough to be inserted into the notch 309 and to come into contact with the edge 370 of the blade holder 304, such as but not limited to, a piece of wire, a piece of string, or a piece of rope.

The folding knife 300, in some configurations, also includes an aperture 322 that is generally located proximate to the rear end 303 of the handle 302 and extends from the first side 361 of the handle 302 all the way through the handle 302 to the second side 363 of the handle 302. By some approaches, the aperture 322 in the handle 302 is positioned such that when the folding knife 200 is being rotated to fold into its retracted position the edge 370 of the utility blade 305 will pass through the aperture 322 in the handle 302, such that if an object such as a piece of electrical wire were inserted into the aperture 322 as the blade holder 304 is rotated to fold into its retracted position it will come into contact with the edge 370 of the utility blade 305 and cut the object that was inserted through the aperture 322 in the body 302 of the folding knife 300.

The folding knife 300, in one embodiment, also includes a clip 311 located on the second side of the handle 102 of the folding knife 300. In use, providing a clip 211 on the handle 302 of the folding knife provides the user an easy and convenient way to both store and secure the folding knife 300.

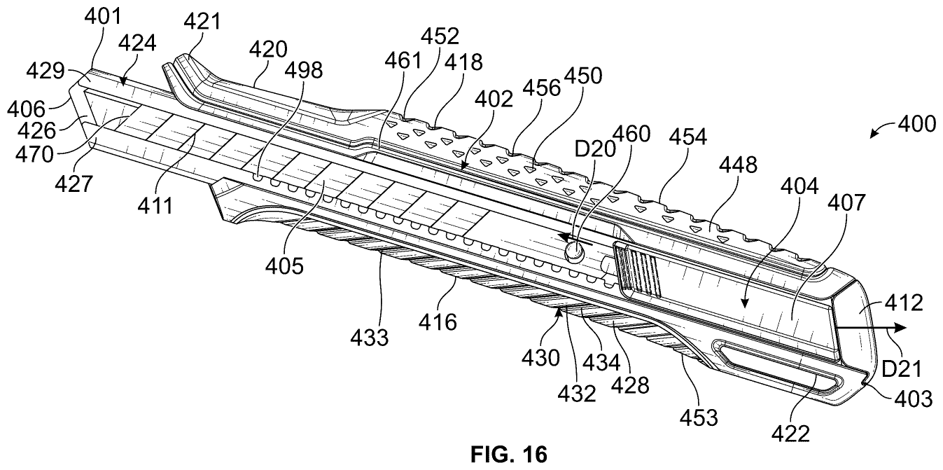

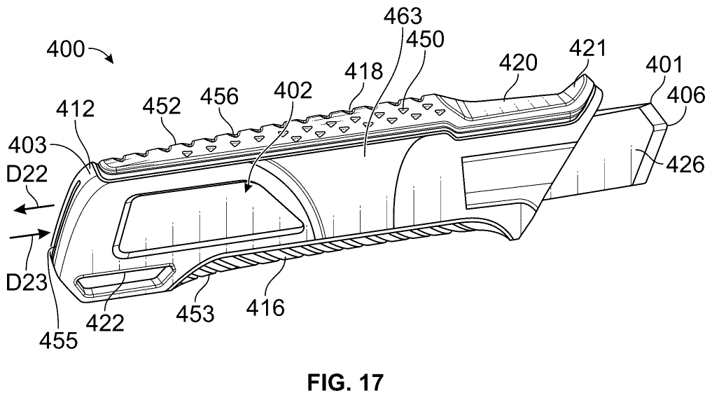

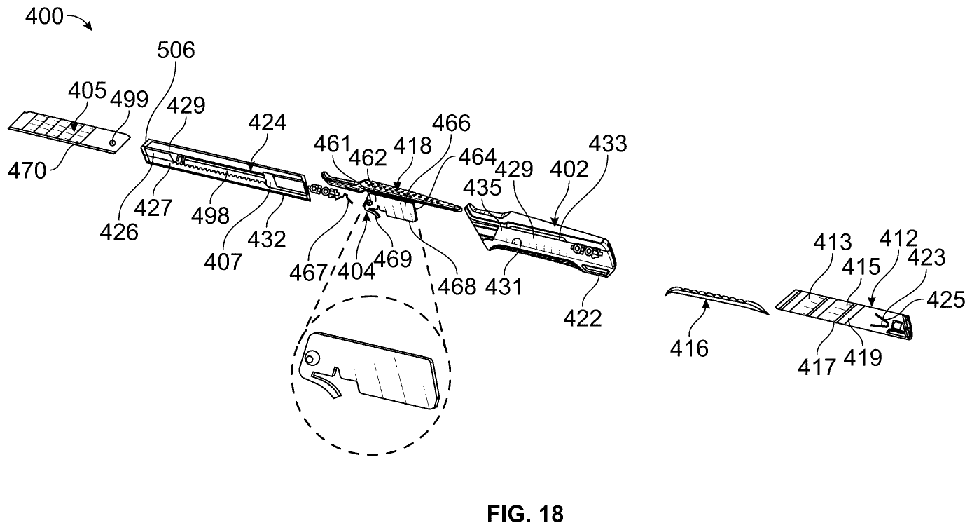

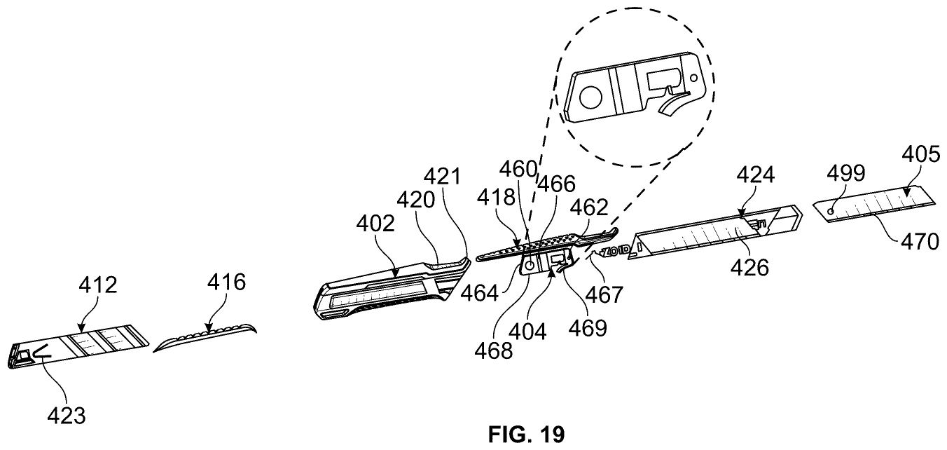

FIGS. 16-19 illustrate one embodiment of a knife, such as a snap knife 400, according to one aspect of the present application. The snap knife 400 has a front end 401 and a rear end 403, a top side or a top surface 452 and a bottom side or a bottom surface 453 and a first side 461 and a second side 463. The snap knife 400 includes a handle 402 that can be formed from any material generally known in the art that is strong and durable such as, but not limited to a metal or plastic material.

According to one aspect of the present application the plastic material of the handle 402 may be, but is not limited to being, an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof, among others.

Similar to some of the previous embodiments discussed, the snap knife 400 includes one or more grips. In some configurations, the snap knife 400 includes a first grip 416 and a second grip 418. In one embodiment, the first grip 416 and the second grip 418 are made from a material that is easy and/or comfortable for a user to grasp with their hands, such as, but not limited to a rubber material. Examples of such rubber materials include, but are not limited to, Natural Rubber (NR), a Styrene-butadiene rubber (SBR), a Butyl (IIR), a Nitrile (NBR), a Neoprene® (CR), a Ethylene Propylene Diene Monomer (EPDM), a Silicone (Q), a Viton® (FKM), a Polyurethane (AU), and/or a Hydrogenated Nitrile (HNBR). In another approach, the first grip 116 and the second grip 118 may be made from a plastic material such, as but not limited to, a Thermoplastic Elastomer (TPE) or a Thermoplastic Rubber (TPR).

As illustrated, the first grip 416 extends at least partially along the first side 461 of the handle 402, at least partially along the bottom side 453 of the handle 402, and at least partially along the second side 463 of the handle 402 while the second grip extends at least partially along the first side 461 of the handle, at least partially along the top side 452 of the handle 402, and at least partially along the second side of the handle 402. In other configurations, the first grip 416 and the second grip 418 may extend over more or less of the handle.

In some configurations, the first grip 416 includes a textured surface or pattern to facilitate increased friction between the handle and the hand in a comfortable manner. In one exemplary approach, the first grip 416 has a repeating pattern with a surface 428 having a plurality of valleys 430. By one approach, the repeating pattern includes a surface 128 with valleys that extend in a crosswise manner from the first side 461 of the handle 402, along the bottom side 453 of the handle, and to the second side. In some configurations, the valleys or repeating surface may extend upward onto the first side 461 and/or up the second side 463 of the handle 402. By one approach, the surface 428 is generally smooth. The valleys 430 generally have a first angular side 432 and a second angular side 434 that meet to form a lowermost portion 433. In some of the configurations, the lowermost portion 433 is a linear depression that extends lengthwise across the grip. In use, the valleys 430 extending in a crosswise manner across the first grip 416 provide a means of traction to prevent a user's hand from slipping while using the utility knife 400.

Similarly, the second grip 418 also may include a textured surface or patter facilitating an increase of friction between the handle and the user's hand. In one approach, the second grip 418 has a surface 448 that has a plurality of discrete protrusions 450 disposed thereon. In some embodiments, the discrete protrusions 450 are disposed along the first side 461 and the second side 463 of the handle 402. In some configurations, the surface 448 is generally smooth in between the discrete protrusions 450. By some approaches, the plurality of discrete protrusions 450 are generally, but are not required to be, uniformly spaced out along the surface 448 of the second grip 418. The second grip 418 also may include a plurality of ridges or plurality of fins 454 interspersed between a plurality of notches, depressions, or gullies 456 that are at least partially extending along the top side 452 of the handle 402. The plurality of discrete protrusions 450 provided on the second grip 418 typically provide an additional means of traction to prevent a user's hand from slipping while using the utility knife 400.

Thus, in some configurations, a snap knife having a first grip 416 that extends at least partially along the first side 461 of the handle 402, the bottom surface 453 of the handle 402, and at least partially along the second side 463 of the handle 402 and a second grip 418 that extends at least partially along the first side 461 of the handle 402, the top surface 452 of the handle 402, and the second side 463 of the handle 402 helps maximizes the amount of gripping surface a user's hand will come into contact with when gripping the handle 402 of the snap knife 400 disclosed herein.

In one illustrative approach, the snap knife 400 also includes a thumb grip 420 that is located along the top surface 452 of the handle 402 and is positioned proximate to the front end 401 of the handle 402. Located on the top surface 452 of the handle 402, the thumb grip 420 may include a lip 421. When in use, the lip 421 acts as an additional pressure point for a user to apply a downward force on a piece of material being cut by the snap knife 400 as well as a stopping point to prevent a user's thumb from slipping off the thumb grip 420 when using the snap knife 400 to cut a piece of material.

In some configurations, the handle 402 includes an interior cavity 429 having a first flange 431 and a second flange 433 with a wall 435 extending therebetween. The interior cavity 429 of the handle 402 may be configured to receive a blade track 424. The blade track 424, in some configurations, includes a first flange 427 and a second flange 429 with a sidewall 426 extending therebetween. The blade track 424 is configured to receive a blade holder 404 and a slide button 407. The first flange 427 of the blade track 424 may include a plurality of teeth 498 that are configured to engage with a flange 469 on the blade holder 404 and lock the blade holder 404 when the blade holder 404 is slid along the blade track 424. In one illustrative embodiment, the blade holder 404 has a protrusion 461 located on a sidewall 462 of the blade holder 404 that is configured to receive an aperture 499 in a utility blade and thereby secure the utility blade 405 to the blade holder 404. The blade holder 404 further may be configured to be coupled to the slide lock 407, such that when the slide lock 407 is actuated by a user to move the slide lock 407 along the blade track 424 it will also move the blade holder 404 and the utility blade 405 secured to the blade holder 404 along the blade track 424 in the direction that the user is actuating the slide lock 407 down the blade track 424.

The handle 402 also may include a storage compartment cavity 455 that is located within the interior of the handle 402. Positioned within the storage compartment cavity 455 is a storage compartment 412 that can be removed from the storage compartment cavity by sliding the storage compartment 412 in a first direction D22 and then inserted into the storage compartment cavity 455 by sliding the storage compartment 412 in a second direction D23.

In one embodiment, the storage compartment 412 has a surface 413 extending between a first sidewall 415 and a second sidewall 417. The storage compartment 412 may include a series of bars extending between the first sidewall 415 and the second sidewall 417 of the storage compartment 412 that are configured to prevent utility blades 405 from falling out of the storage compartment 412 when the storage compartment 412 is removed from the storage compartment cavity 455 located within the handle 402. In some embodiments, the surface 413 of the storage compartment 412 has a cutout section 425 having a protrusion 423 positioned within the cutout section 425 of the surface 413 of the storage compartment 412. The protrusion 423 is configured to receive the aperture 499 that extends through the utility blade 405, such that the protrusion 423 secures the utility blades 405 in place when stored in the storage compartment 412 by inserting the apertures 499 of the utility blades 405 through the protrusion 423 located along the surface of the storage compartment 412.

Located at the rear end 403 of the snap knife 400 may include an aperture 422 that extends through the handle 402. The aperture 422 may be used as a hanging point in which to hang the snap knife 400 through.

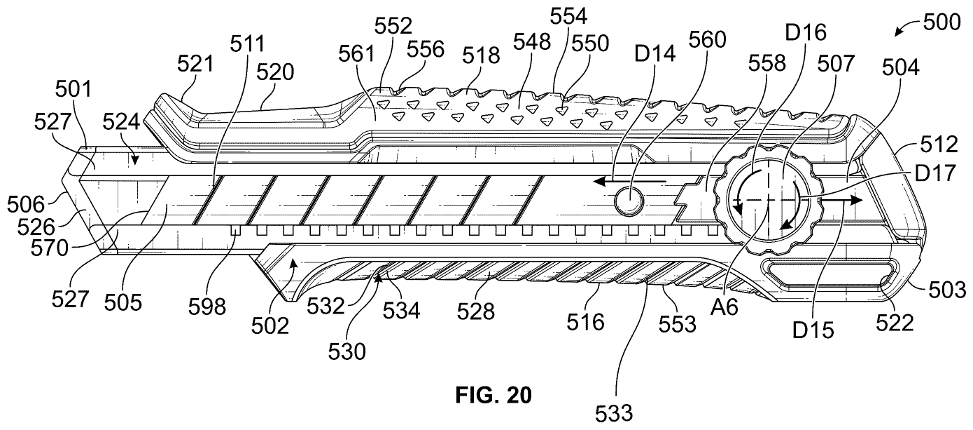

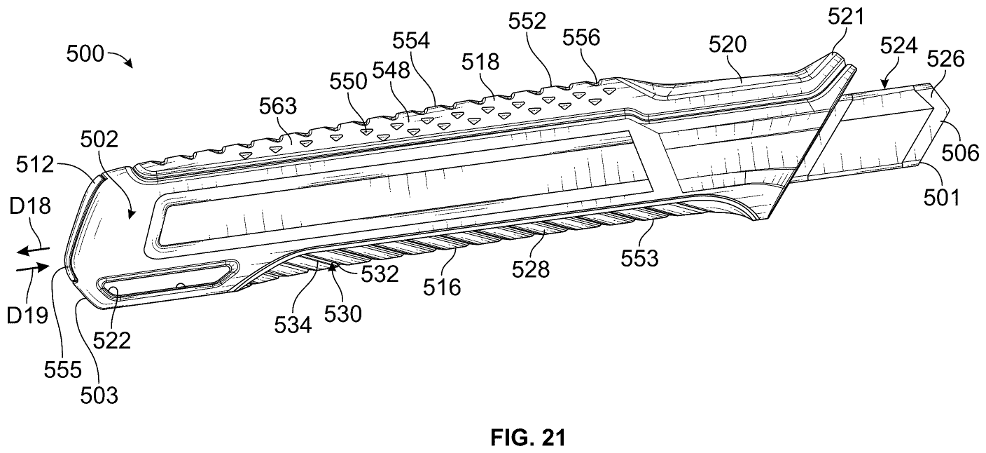

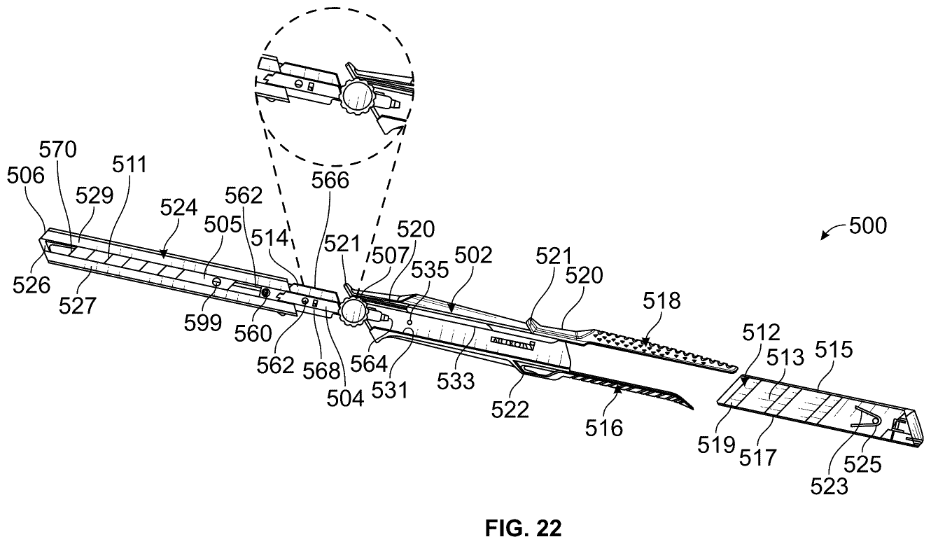

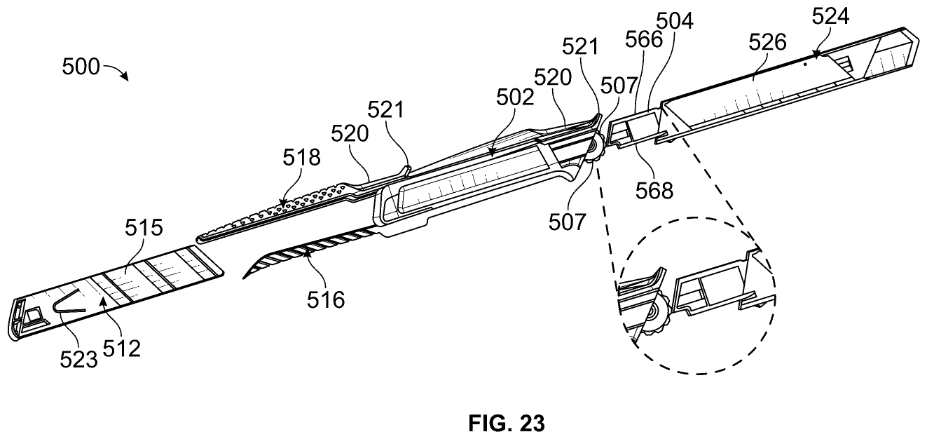

FIGS. 20-23 illustrate another embodiment of a knife, such as a snap knife 500, according to one aspect of the present application. The snap knife 400 has a front end 501 and a rear end 503, a top side or a top surface 552 and a bottom side or bottom surface 553 and a first side 561 and a second side 563.

According to one aspect of the present application the plastic material of the handle 502 may be, but is not limited to being, an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof, among others.

Similar to some of the previous embodiments discussed, the snap knife 500 includes one or more grips. In some configurations, the snap knife 500 includes a first grip 516 and a second grip 518. In one embodiment, the first grip 516 and the second grip 518 are made from a material that is easy and/or comfortable for a user to grasp with their hands, such as, but not limited to a rubber material. Examples of such rubber materials include, but are not limited to, Natural Rubber (NR), a Styrene-butadiene rubber (SBR), a Butyl (IIR), a Nitrile (NBR), a Neoprene® (CR), a Ethylene Propylene Diene Monomer (EPDM), a Silicone (Q), a Viton® (FKM), a Polyurethane (AU), and/or a Hydrogenated Nitrile (HNBR). In another approach, the first grip 116 and the second grip 118 may be made from a plastic material such, as but not limited to, a Thermoplastic Elastomer (TPE) or a Thermoplastic Rubber (TPR).

As illustrated, the first grip 516 extends at least partially along the first side 561 of the handle 502, at least partially along the bottom side 553 of the handle 502, and at least partially along the second side 563 of the handle 502 while the second grip extends at least partially along the first side 561 of the handle, at least partially along the top side 552 of the handle 502, and at least partially along the second side of the handle 502. In other configurations, the first grip 516 and the second grip 518 may extend over more or less of the handle.

In some configurations, the first grip 516 includes a textured surface or pattern to facilitate increased friction between the handle and the hand in a comfortable manner. In one exemplary approach, the first grip 516 has a repeating pattern with a surface 528 having a plurality of valleys 530. By one approach, the repeating pattern includes a surface 128 with valleys that extend in a crosswise manner from the first side 561 of the handle 502, along the bottom side 553 of the handle, and to the second side. In some configurations, the valleys or repeating surface may extend upward onto the first side 561 and/or then up the second side 563 of the handle 502. The valleys 530 generally have a first angular side 532 and a second angular side 534 that meet to form a lowermost portion 533 in each of the valleys 530. In use. the valleys 530 extending in a crosswise manner across the first grip 516 provide a means of traction to prevent a user's hand from slipping while using the utility knife 500.

Similarly, the second grip 518 also may include a textured surface or patter facilitating an increase of friction between the handle and the user's hand. In one approach, the second grip 518 having a surface 548 that has a plurality of discrete protrusions 550 disposed thereon. In some embodiments, the discrete protrusions 550 along the first side 561 and the second side 563 of the handle 502. In some approaches, the surface 548 is generally smooth. The plurality of discrete protrusions 550 may be, but are not required to be, uniformly spaced out along the surface 548 of the second grip 518. The second grip 518 also may include a plurality of ridges or a plurality of fins 554 interspersed between a plurality of notches, depressions, or gullies 556 that are at least partially extending along the top side 552 of the handle 502. The plurality of discrete protrusions 550 provided on the second grip 518 provide an additional means of traction to prevent a user's hand from slipping while using the utility knife 500.

Thus, in some configurations, a snap knife having a first grip 516 that extends at least partially along the first side 561 of the handle 502, the bottom surface 553 of the handle 502, and at least partially along the second side 563 of the handle 502 and a second grip 518 that extends at least partially along the first side 561 of the handle 502, the top surface 552 of the handle 502, and the second side 563 of the handle 502 helps maximizes the amount of gripping surface a user's hand will come into contact with when gripping the handle 502 of the snap knife 500 disclosed herein.

In one illustrative approach, the snap knife 500 also includes a thumb grip 520 that is located along the top surface 552 of the handle 502 and is positioned proximate to the front end 501 of the handle 502. The top surface 552 also may include a lip 521 that is located proximate to the thumb grip 520. When in use, the lip 521 acts as an additional pressure point for a user to apply a downward force on a piece of material being cut by the snap knife 500 as well as a stopping point to prevent a user's thumb from slipping off the thumb grip 520 when using the snap knife 500 to cut a piece of material.

In some configurations, the handle 502 includes an interior cavity having a first flange 531 and a second flange 533 with a wall 535 extending therebetween. The interior cavity 529 of the handle 502 may be configured to receive a blade track 524. The blade track 524, in some configurations, includes a first flange 527 and a second flange 529 with a sidewall 526 extending therebetween. The blade track 524 is configured to receive a blade holder 504 and rotational blade lock 507. The blade holder 504 may have a protrusion 562 located on a sidewall 568 of the blade holder 504 that is configured to receive an aperture 599 in a utility blade 505 and thereby secure the utility blade 505 to the blade holder 504. The blade holder 504 may be further configured to be coupled to the rotational slide lock 507, such that when the rotational slide lock 507 is actuated by a user to move the rotational slide lock 507 along the blade track 524 it will also move the blade holder 504 and a utility blade 505 that has been coupled to the blade holder 504.

By one approach, the rotational slide lock 507 is configured to be rotated about axis A6 in first direction D16 and a second direction D17. The rotational slide lock 507 is typically configured to control the position and movement of the blade holder 504 when the blade holder is inserted into the blade track 524. To control the movement of the blade holder's position 504 along the blade track 524, a user will generally rotate the rotational slide lock 507 about axis A6 in direction D17. Rotating the rotational slide lock 507 in in direction D17 about axis A6 will cause a fastener coupled to the rotational slide lock 507 to come to be extended and come into contact with the wall 535 located within the interior cavity of the handle 502. In use, if the rotational slide lock 507 is sufficiently rotated about axis A6 in direction D17 it can prevent any further movement of blade holder 504 along the blade track 524.

Likewise, if a user wished to move the blade holder 504 along the blade track 524 a user may then rotate the rotational slide lock in direction D16 about axis A6 to release the fastener from engaging with the wall of the internal cavity of the handle 502 thereby freeing the blade holder 504 and allowing the blade holder 504 to move freely along the blade track 524.

The handle 502 also may include a storage compartment cavity 555 that is located within the interior of the handle 502. Positioned within the storage compartment cavity 555 is a storage compartment 512 that can be removed from the storage compartment cavity by sliding the storage compartment 512 in a first direction D22 and then inserted into the storage compartment cavity 555 by sliding the storage compartment 512 in a second direction D23.

In one embodiment, the storage compartment 512 has a surface 513 extending between a first sidewall 515 and a second sidewall 517. The storage compartment 512 may include a series of bars extending between the first sidewall 515 and the second sidewall 517 of the storage compartment 512 that are configured to prevent utility blades 505 from falling out of the storage compartment 512 when the storage compartment 512 is removed from the storage compartment cavity 555 located within the handle 502. In some embodiments, the surface 513 of the storage compartment 512 has a cutout section 525 having a protrusion 523 positioned within the cutout section 525 of the surface 513 of the storage compartment 512. The protrusion 523 is configured to receive the aperture 599 that extends through the utility blade 505, such that the protrusion 523 secures the utility blades 505 in place when stored in the storage compartment 512 by inserting the apertures 599 of the utility blades 505 through the protrusion 523 located along the surface of the storage compartment 512.

Located at the rear end 503 of the snap knife 500 may include an aperture 522 that extends through the handle 502. The aperture 522 may be used as a hanging point in which to hang the snap knife 500 through.

The use of the terms “a” and “an” and “the” and similar referents used in the present application (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate what is being disclosed by the present application and does not pose a limitation on the scope of the disclosure in the present application unless otherwise claimed. No language in the specification should be construed as indicating any non-claimed element as essential to the practice of what is disclosed by the present application.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A knife comprising:
a handle;
a blade holder connected to the handle and configured to receive a utility blade;
the handle having a first grip located on a first side of the handle and a second grip located on a second side of the handle opposite the first side of the handle;
the first grip having a repeating pattern with a plurality of valleys having a first angular side and a second angular side, wherein the first angular side and the second angular side meet to form a lowermost portion of the valley;
the second grip having a surface with a plurality of discrete protrusions thereon, and a ridged surface.

2. The knife of claim 1, wherein the plurality of protrusions is disposed on a surface generally perpendicular relative to the ridged surface.

3. The knife of claim 2, wherein each of the plurality of discrete protrusions are generally triangular in shape.

4. The knife of claim 1, wherein the handle has a latch that closes an aperture in the handle when the latch is in a first position and that opens an aperture in the handle when the latch is in a second position.

5. The knife of claim 4, wherein the latch is connected to a spring such that the spring biases against the latch to keep the latch in the first position.

6. The knife of claim 1, further comprising a rotatable storage compartment door that is rotatable about an axis of the handle.

7. The knife of claim 6, wherein the storage compartment is configured to store at least one utility blade.

8. The knife of claim 7, wherein the storage compartment has a blade clip that biases against the at least one utility blade to keep the utility blade in place when placed in the storage compartment.

9. The knife of claim 1, wherein the handle includes a blade lock release button that when actuated causes a blade lock release of the blade holder to release the utility blade.

10. A knife comprising:
a handle;
a blade holder connected to the handle and configured to receive a utility blade;
the handle having a first z-shaped grip portion and a second z-shaped grip portion;
wherein the first z-shaped grip portion and the second z-shaped grip portion extend at least partially along a first grip located on the handle.

11. The knife of claim 10, wherein the first grip includes a repeating pattern with a plurality of valleys having a first angular side and a second angular side.

12. The knife of claim 11, wherein the first angular side and the second angular side meet to form a lowermost portion of the valley

13. The knife of claim 10, wherein the handle includes a second grip portion located opposite of the first grip portion on the hand.

14. The knife of claim 13, wherein the second grip includes a surface with a plurality of discrete protrusions thereon, and a ridged surface.

15. The knife of claim 14, wherein the plurality of discrete protrusions is disposed on a surface generally located perpendicular to the ridged surface.

16. The knife of claim 15, wherein the plurality of protrusions are generally triangular in shape.

17. The knife of claim 15, wherein the second grip extends along at least a first side, a second side, and a third side of the handle.

18. The knife of claim 10, wherein the first grip extends along at least a first side, a second side, and a third side of the handle.

19. The knife of claim 10, wherein the handle has a latch that closes an aperture in the handle when the latch is in a first position and that opens an aperture in the handle when the latch is in a second position.

20. The knife of claim 10, further comprising a rotatable storage compartment door that is rotatable about an axis of the handle.

21. A knife comprising:
a blade housing with a blade mount;
a blade movable between at least an extended position where the blade extends partially beyond the blade housing and a retracted position where the blade is primarily disposed within the blade housing via a slide lock, wherein the blade housing has a notch through which the blade is partially exposed when the blade is disposed in the retracted position; and
a handle having a first grip, a second grip disposed on an opposing side of the handle from the first grip and a latch opening disposed on an end of the handle opposite the blade housing;
wherein the first grip includes a first patterned surface having a series of crosswise channels and the second grip includes a patterned surface with a plurality of discrete protrusions.

22. The knife of claim 21 wherein the second grip further includes a third patterned surface disposed atop the handle in between portions of the first patterned surface, the third patterned surface includes a series of fins with each of the fins having at least a sloping side and a shelf.

23. The knife of claim 22 wherein the fins further include a flat top surface disposed between the sloping side and the shelf.

24. The knife of claim 21 wherein the handle further comprises a contoured z-shape configuration disposed adjacent the second patterned grip surface.

25. The knife of claim 21 wherein the plurality of discrete protrusions have a triangular shape.

26. The knife of claim 21 wherein the crosswise creases having a first and a second surface creating creases with a V-shaped cross section.

27. A knife comprising:
a blade housing;
a blade mount that is rotatably connected to the blade housing;
a blade rotatably movable between an extended position and a closed position;
a handle having a first grip, a second grip disposed on an opposing side of the handle from the first grip, wherein the first grip includes a first patterned surface having a series of crosswise channels and the second grip includes a patterned surface with a plurality of discrete protrusions.

28. The knife of claim 27 further comprising a rotatable blade drawer configured to receive at least one additional blade, wherein the rotatable blade drawer has one or more magnetic elements to securely retain the at least one additional blade during movement of the rotatable blade drawer.

29. The knife of claim 27 further comprising an aperture disposed at an end of the housing opposite the blade and the aperture configured to receive a piece of wire and cooperate with the blade to strip an outer sheath of the piece of wire.

30. The knife of claim 27 wherein the second grip further includes a third patterned surface disposed atop the handle in between portions of the first patterned surface, the third patterned surface includes a series of fins with each of the fins having at least a sloping side and a shelf.

31. The knife of claim 28 wherein the fins further include a flat top surface disposed between the sloping side and the shelf.

32. The knife of claim 28 wherein the handle further comprises a contoured z-shape configuration disposed adjacent the second patterned grip surface.

33. The knife of claim 28 wherein the plurality of discrete protrusions have a triangular shape.

34. The knife of claim 28 wherein the crosswise creases having a first and a second surface creating creases with a V-shaped cross section.

35. A knife comprising:
a handle;
a blade holder connected to the handle and configured to receive a utility blade;
the handle having a first grip located on a first side of the handle and a second grip located on a second side of the handle opposite the first side of the handle;
the first grip having a repeating pattern with a plurality of valleys;
the second grip having a surface with a plurality of discrete protrusions thereon, and a ridged surface perpendicular to the plurality of discrete protrusions; and
a thumb grip disposed proximate to a terminal end of the handle.

36. The knife of claim 35, wherein the thumb grip is located along a top surface of the handle.

37. The knife of claim 36, wherein the thumb grip has a top surface consisting of a repeating pattern of ridges.

38. The knife of claim 35, further comprising a lip disposed between the terminal end of the handle and the thumb grip.

39. The knife of claim 35, wherein the thumb grip is located along a top surface of the blade holder.

40. The knife of claim 38, wherein the thumb grip has a top surface consisting of a repeating pattern of ridges.

41. The knife of claim 35 wherein the utility blade is removable from the blade holder.
